(19) United States
(12) Patent Application Publication
(10) Pub. No.: US 2023/0186817 A1
(43) Pub. Date: Jun. 15, 2023

(54) LIGHT SOURCE DRIVING CIRCUIT AND METHOD FOR DRIVING LIGHT SOURCE

(71) Applicant: Innolux Corporation, Miaoli County (TW)

(72) Inventors: Ming-Feng Hsieh, Miaoli County (TW); Cheng-Tso Hsiao, Miaoli County (TW); Chien-Hung Chan, Miaoli County (TW); Huang-Chi Chao, Miaoli County (TW)

(73) Assignee: Innolux Corporation, Miaoli County (TW)

(21) Appl. No.: 17/984,180

(22) Filed: Nov. 9, 2022

(30) Foreign Application Priority Data
Dec. 15, 2021 (CN) 202111534560.1

(51) Int. Cl. G09G 3/20

(52) U.S. Cl. CPC G09G 3/2007; G09G 2320/0257; G09G 2320/0626

(57) ABSTRACT

A light source driving circuit and a method for driving a light source are provided. The light source driving circuit includes a filter. The filter is configured to receive a pixel signal. The filter selects one filter parameter from multiple filter parameters according to a gray level value of the pixel signal. The filter performs a filter operation on the pixel signal according to the selected filter parameter, so as to output a driving signal to drive a light source module. The filter parameters include a first filter parameter, a second filter parameter, and a third filter parameter. The second filter parameter is obtained by performing an interpolation operation on the first filter parameter and the second filter parameter via the filter.

### CROSS-REFERENCE TO RELATED APPLICATION

This application claims the priority benefit of China application serial no. 202111534560.1, filed on Dec. 15, 2021. The entirety of the above-mentioned patent application is hereby incorporated by reference herein and made a part of this specification.

### BACKGROUND

### Technical Field

The disclosure relates to a light source driving circuit with a local dimming function and a method for driving a light source.

### Description of Related Art

In current display devices with multiple local dimming, halo phenomenon has always been one of the reasons for poor picture quality (PQ). The halo phenomenon is particularly obvious when the display devices display at medium and low gray levels. Specifically, at the medium and low gray levels, the display devices with a function of multiple local dimming are prone to halo at an edge of an image due to a design of a spatial filter and the number of backlight areas, resulting in a decrease in visual quality perceived by human eyes. In the existing display devices with multiple local dimming, the design of the spatial filter is to use a filter parameter for all pixel signals of the image, regardless of a level of a gray level value it has. Therefore, the existing display devices with multiple local dimming may have a phenomenon that halo is not easy to occur at the low grey level, but brightness at the high gray level is insufficient, or a phenomenon that halo is easy to occur at the low grey level, and the brightness at the high gray level is required to be improved.

### SUMMARY

The disclosure provides a light source driving circuit and a method for driving a light source, and a filter adopts different filter parameters at each of gray levels, which may optimize a local dimming function of the light source driving circuit and improve display quality of a display panel.

A light source driving circuit in the disclosure includes a filter. The filter is configured to receive a pixel signal. The filter selects one filter parameter from multiple filter parameters according to a gray level value of the pixel signal. The filter performs a filter operation on the pixel signal according to the selected filter parameter to output a driving signal to drive a light source module. The filter parameters include a first filter parameter, a second filter parameter, and a third filter parameter. The second filter parameter is obtained by performing an interpolation operation on the first filter parameter and the third filter parameter via the filter.

In the embodiment of the disclosure, when the gray level value of the pixel signal is less than or equal to a first threshold value, the filter selects the first filter parameter.

In the embodiment of the disclosure, when the gray level value of the pixel signal is greater than the first threshold value and less than a second threshold value, the filter selects the second filter parameter.

In the embodiment of the disclosure, when the gray level value of the pixel signal is greater than or equal to the second threshold value, the filter selects the third filter parameter.

In the embodiment of the disclosure, the pixel signal includes pixel data of multiple pixels, and the filter calculates the gray level value of the pixel signal according to a maximum value of the pixel data and an average value of the pixel data.

A method for driving a light source in the disclosure is configured to drive a light source module. The method for driving the light source includes the following. A pixel signal is received. One filter parameter is selected from multiple filter parameters according to a gray level value of the pixel signal. A filter operation is performed on the pixel signal according to the selected filter parameter to output a driving signal to drive the light source module. The filter parameters include a first filter parameter, a second filter parameter, and a third filter parameter. The second filter parameter is obtained by performing an interpolation operation on the first filter parameter and the third filter parameter.

In the embodiment of the disclosure, the step of selecting the one filter parameter from the filter parameters according to the gray level value of the pixel signal includes the following. The first filter parameter is selected when the gray level value of the pixel signal is less than or equal to a first threshold value.

In the embodiment of the disclosure, the step of selecting the one filter parameter from the filter parameters according to the gray level value of the pixel signal includes the following. The second filter parameter is selected when the gray level value of the pixel signal is greater than the first threshold value and less than a second threshold value.

In the embodiment of the disclosure, the step of selecting the one filter parameter from the filter parameters according to the gray level value of the pixel signal includes the following. The third filter parameter is selected when the gray level value of the pixel signal is greater than or equal to the second threshold value.

In the embodiment of the disclosure, the pixel signal includes pixel data of multiple pixels. The method for driving the light source further includes the following. The gray level value of the pixel signal is calculated according to a maximum value of the pixel data and an average value of the pixel data.

In order for the aforementioned content to be more comprehensible, several embodiments accompanied with drawings are described in detail below.

### BRIEF DESCRIPTION OF THE DRAWINGS

FIG. 1A is a block diagram of a light source driving circuit of a display device according to an embodiment of the disclosure.

FIG. 1B is a schematic diagram of a filter parameter according to the embodiment of FIG. 1A.

FIG. 2 is a flow chart of steps of a method for driving a light source according to an embodiment of the disclosure.

FIG. 3A is a schematic diagram of output intensity of a light source module and a corresponding filter parameter thereof according to an embodiment of the disclosure.

FIG. 3B is a schematic diagram of output intensity of a light source module and a corresponding filter parameter thereof according to another embodiment of the disclosure.

FIG. 4A is a schematic diagram of an image frame, a filter parameter, and an output of a light source module according to an embodiment of the disclosure.

FIG. 4B is a schematic diagram of an image frame, a filter parameter, and an output of a light source module according to another embodiment of the disclosure.

FIG. 5 is a flow chart of steps of a method for driving a light source according to another embodiment of the disclosure.

### DETAILED DESCRIPTION OF DISCLOSED EMBODIMENTS

The disclosure can be understood by referring to the following detailed description in combination with the accompanying drawings. It should be noted that in order to make it easy for the reader to understand and for the simplicity of the drawings, the multiple drawings in this disclosure only depict a part of the electronic device, and the specific components in the drawings are not drawn according to actual scale. In addition, the number and size of each component in the drawings are only for exemplary purpose, and are not intended to limit the scope of the disclosure.

In the following description and claims, the terms “contain” and “include” are open-ended terms, so they should be interpreted as “include but not limited to...”.

It should be understood that although the terms such as first, second, and third may be used to describe various components, the components are not limited to the terms. The terms are merely used to distinguish a single component from other components in the specification. Different terms may be used in the claims, and replaced by first, second , third, etc. in the order in which the components are declared in the claims. Therefore, in the following specification, the first component may be the second component in the claims.

In some embodiments of the disclosure, the terms such as “connect”, “interconnect”, etc. regarding bonding and connection, unless otherwise defined, may indicate that two structures are in direct contact, or may also indicate that the two structures are not in direct contact, and there are other structures located therebetween. In addition, the terms regarding bonding and connection may also include the case where both structures are movable, or both structures are fixed. Furthermore, the term “couple” includes any direct and indirect means of electrical connection.

The electronic device in the disclosure may include a display device, an antenna device, a sensing device, a lighting device, or a splicing device, but the disclosure is not limited thereto. The electronic device may include bendable or flexible electronic devices. The electronic device may include electronic elements. The electronic device includes, for example, a liquid crystal layer or a light emitting diode (LED). The electronic elements may include passive devices and active devices, such as capacitors, resistors, inductors, variable capacitors, filters, diodes, transistors, sensors, MEMS devices, liquid crystal chips, and controllers, but the disclosure is not limited thereto. The diodes may include light emitting diodes or photodiodes. The light emitting diodes may include, for example, organic light emitting diodes (OLEDs), mini LEDs, micro LEDs, quantum dot LEDs, fluorescence, phosphor, other suitable materials, or a combination of the above, but the disclosure is not limited thereto. The sensors may include, for example, capacitive sensors, optical sensors, electromagnetic sensors, fingerprint sensors (FPS), touch sensors, antennas, pen sensors, etc., but the disclosure is not limited thereto. The controllers may include, for example, timing controllers, etc., but the disclosure is not limited thereto. Hereinafter, the disclosure will be described by taking the display device as the electronic device, but the disclosure is not limited thereto.

Reference will now be made in detail to the exemplary embodiments of the disclosure, and examples of the exemplary embodiments are illustrated in the accompanying drawings. Whenever possible, the same reference numerals are used in the drawings and descriptions to refer to the same or similar parts.

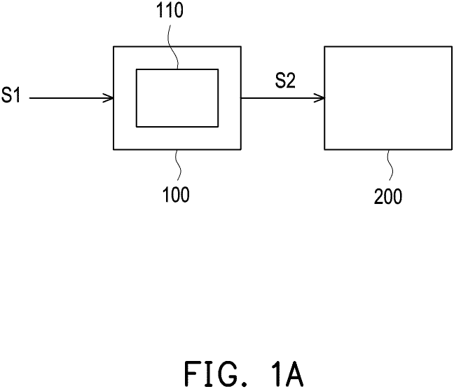

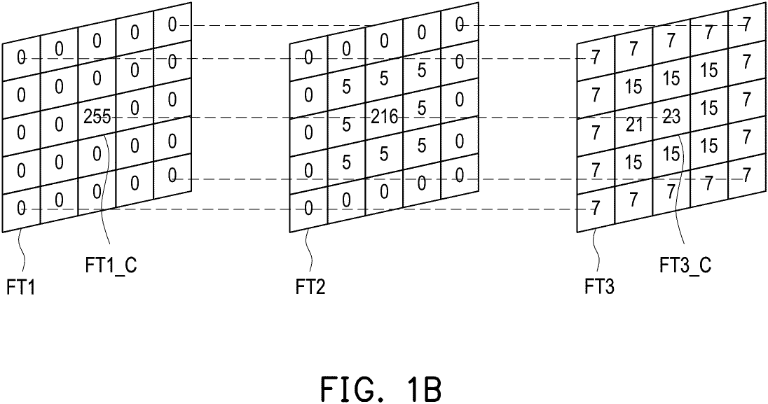

FIG. 1A is a block diagram of a light source driving circuit of a display device according to an embodiment of the disclosure. FIG. 1B is a schematic diagram of a filter parameter according to the embodiment of FIG. 1A. Referring to FIG. 1A and FIG. 1B, a light source driving circuit 100 includes a filter 110. The filter 110 is configured to receive a pixel signal S1. The filter 110 selects one filter parameter from multiple filter parameters FT1, FT2, and FT3 according to a gray level value of the pixel signal S1. Next, the filter 110 performs a filter operation on the pixel signal S1 according to the selected filter parameter, so as to output a driving signal S2 to drive a light source module 200. In an embodiment, the driving signal S2 is, for example, a pulse width modulation (PWM) signal, which is configured to drive a light emitting unit of the light source module 200.

In this embodiment, the light source driving circuit 100 has a local dimming function, which may be configured to drive a local area of the light source module 200 to emit light. The light source module 200 may serve as a light source of a display panel (not shown), and may provide the light source to the display panel. For example, the display panel may be a liquid crystal display panel; the light source module 200 may serve as a backlight source of the display panel, and the display device may be a liquid crystal display device. However, a type of the display device is not limited in the disclosure. The light emitting unit of the light source module 200 may include a light emitting diode chip or a light emitting diode package. For example, the light source module 200 may be one or more series-connected or parallel-connected light emitting diodes, or one or more series-connected or parallel-connected light emitting diode strings. The light emitting diodes may be as described above, and thus the same details will not be repeated in the following.

In this embodiment, the filter 110 may be a hardware circuit which is designed through a hardware description language (HDL) or or any other digital circuit design methods well known to those skilled in the art, and is implemented through a field programmable gate array (FPGA), a complex programmable logic device (CPLD), or an application-specific integrated circuit (ASIC). In addition, in an embodiment, the filter 110 may be a processor with computing capability.

In this embodiment, the filter parameters include the first filter parameter FT1, the second filter parameter FT2, and the third filter parameter FT3, but the disclosure is not limited thereto. The filter 110 performs an interpolation operation on the first filter parameter FT1 and the third filter parameter FT3 to obtain the second filter parameter FT2. The first filter parameter FT1 may be a centralized parameter array, but the disclosure is not limited thereto. When the first filter parameter FT1 is the centralized parameter array, the parameter array thereof has multiple elements; a central element FT1_C thereof has the largest parameter value, and the parameter values of the rest of elements may be zero. The third filter parameter FT3 may be a distributed parameter array, but the disclosure is not limited thereto. When the third filter parameter FT3 is the distributed parameter array, the parameter array thereof has multiple elements; a central element FT3_C thereof has the largest parameter value, and the parameter values of the rest of elements may be centered on the central element and decrease in order to a periphery.

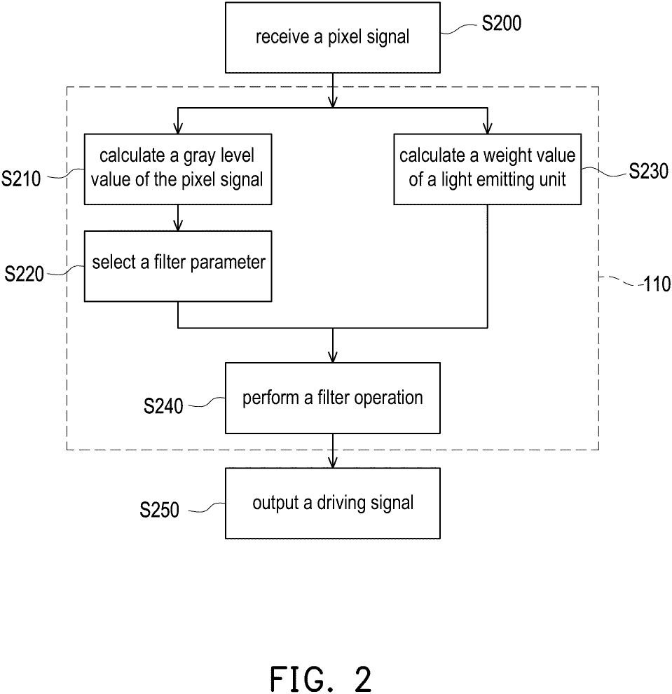

FIG. 2 is a flow chart of steps of a method for driving a light source according to an embodiment of the disclosure. Referring to FIG. 1A and FIG. 2, in step S200, the filter 110 receives the pixel signal S1. In step S210, the filter 110 analyzes the pixel signal S1 to calculate an evaluation value of the pixel signal S1. For example, the pixel signal S1 includes pixel data (e.g., the gray level value) of multiple pixels, and the filter 110 calculates the evaluation value of the pixel signal according to a maximum value of the pixel data and an average value of the pixel data. However, the disclosure is not limited thereto.

Next, in step S220, the filter 110 selects the one filter parameter from the filter parameters FT1, FT2, and FT3 according to the evaluation value of the pixel signal S1 calculated in step S210. For example, in step S220, when the evaluation value of the pixel signal S1 is less than or equal to a first threshold value, the filter 110 selects the first filter parameter FT1. When the evaluation value of the pixel signal S1 is greater than the first threshold value and less than a second threshold value, the filter 110 selects the second filter parameter FT2. When the gray level value of the pixel signal S1 is greater than or equal to the second threshold value, the filter 110 selects the third filter parameter FT3. In this embodiment, the first threshold value may be, for example, a gray level value of 100, and the second threshold value may be, for example, a gray level value of 200. The first threshold value is less than the second threshold value. The setting of the gray level values of the above threshold values is only used for illustration, and is not intended to limit the disclosure.

That is, when the gray level values of the pixels of the pixel signal S1 are at a low gray level, the filter 110 selects the centralized parameter array (the first filter parameter FT1). When the gray level values of the pixels of the pixel signal S1 are at a high gray level, the filter 110 selects the distributed parameter array (the third filter parameter FT3). When the gray level values of the pixels of the pixel signal S1 are between the low gray level and the high gray level, the filter 110 selects a parameter array (the second filter parameter FT2) obtained by performing the interpolation operation on the centralized parameter array and the distributed parameter array.

On the other hand, in step S230, the light source driving circuit 100 calculates a weight value of each of the light emitting units in the local area to be driven in the light source module 200 according to the pixel signal S1. Next, in step S240, the filter 110 performs the filter operation on the pixel signal S1 according to the filter parameter selected in step S210 and the weight value obtained in step S230, so as to output the driving signal S2 to drive the light source module 200 in step S250. In step S240, the filter operation performed on the pixel signal S1 via the filter 110 is , for example, to perform a convolution operation on the selected filter parameter and the weight value output in step S230 to obtain the driving signal S2. The driving signal S2 is, for example, the pulse width modulation signal. Therefore, a calculation result in step S240 includes a duty ratio of the pulse width modulation signal. In step S210 to step S240, the light source driving circuit 100 performs a local dimming operation on the light source module 200.

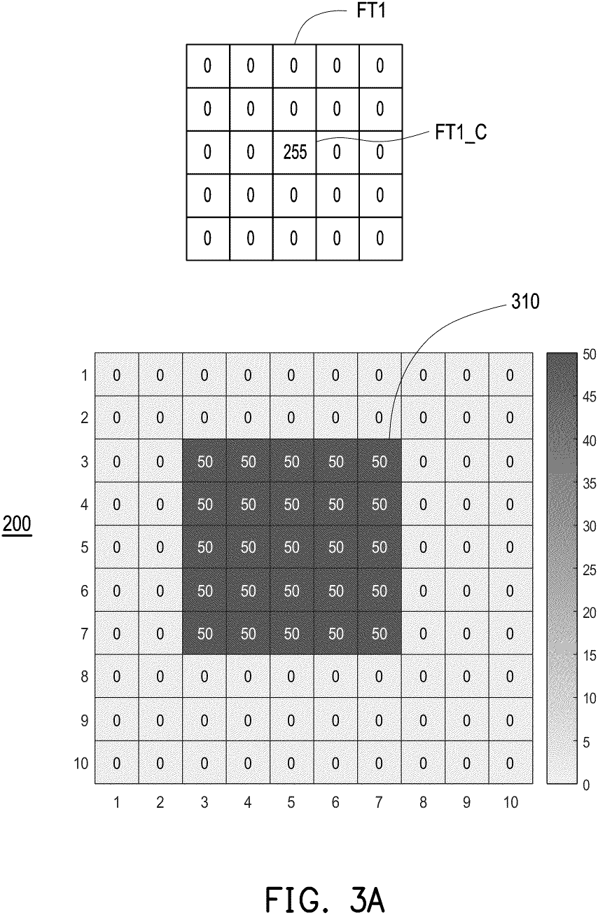

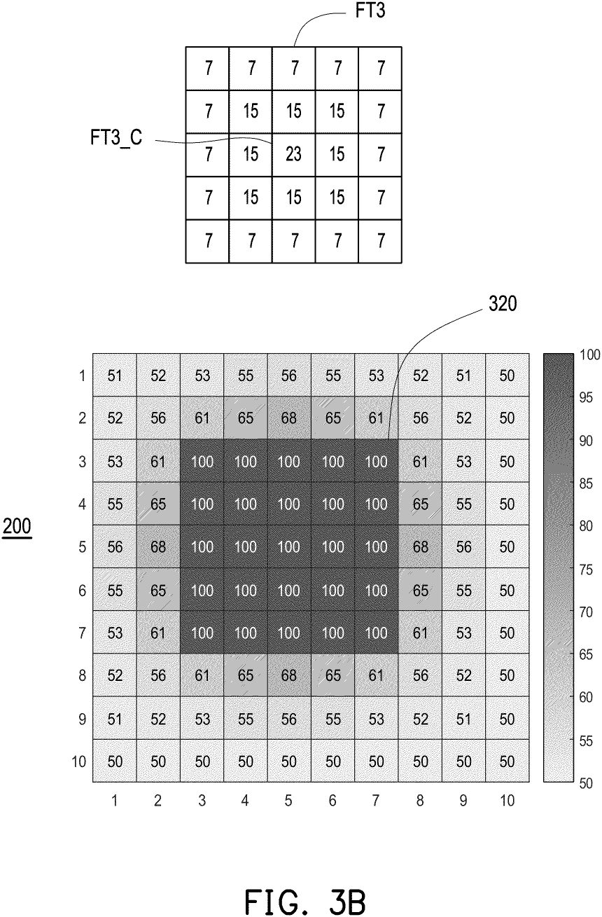

FIG. 3A is a schematic diagram of output intensity of a light source module and a corresponding filter parameter thereof according to an embodiment of the disclosure. In FIG. 3A , the pixel signal S1 is evaluated by the filter 110 as a pixel signal with the low gray level. Therefore, the filter 110 selects the first filter parameter FT1 as the filter parameter, and performs the filter operation on the pixel signal S1 accordingly, so as to output the driving signal S2 to drive the light source module 200 to emit the light. Light-emitting intensity of each of the light emitting units in a local area 310 of the light source module 200 may be as shown in FIG. 3A. Intensity values 0 to 50 are standardized units of intensity, but the disclosure is not limited thereto. According to FIG. 3A, when the pixel signal S1 with the low gray level is input, the light source driving circuit 100 drives the light source module 200 to reduce probability of a halo phenomenon occurring in the local area 310.

FIG. 3B is a schematic diagram of output intensity of a light source module and a corresponding filter parameter thereof according to another embodiment of the disclosure. In FIG. 3B, the pixel signal S1 is evaluated by the filter 110 as a pixel signal with the high gray level. Therefore, the filter 110 selects the third filter parameter FT3 as the filter parameter, and performs the filter operation on the pixel signal S1 accordingly, so as to output the driving signal S2 to drive the light source module 200 to emit the light. Light-emitting intensity of each of the light emitting units in a local area 320 of the light source module 200 may be as shown in FIG. 3B. Intensity values 50 to 100 are standardized units of intensity, but the disclosure is not limited thereto. According to FIG. 3B, when the pixel signal S1 with the high gray level is input, the light source driving circuit 100 drives the light source module 200, and the local area 320 thereof has sufficient brightness to be output to the display panel.

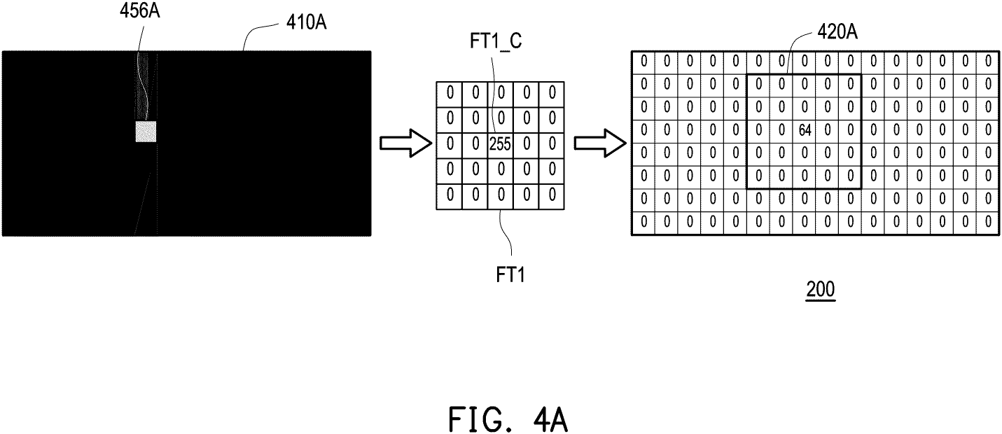

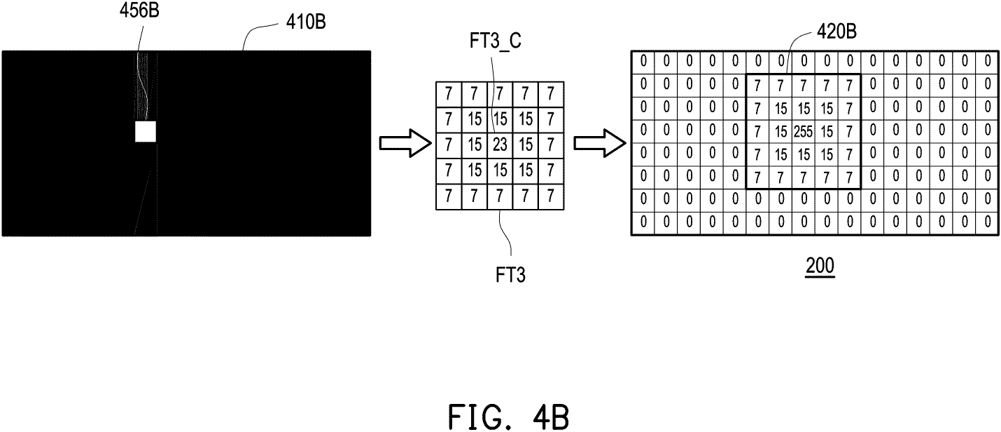

FIG. 4A is a schematic diagram of an image frame, a filter parameter, and an output of a light source module according to an embodiment of the disclosure. Referring to FIG. 1A and FIG. 4A, the pixel signal S1 input to the light source driving circuit 100 includes an image frame 410A. A pixel 456A therein is, for example, set as a pixel with a gray level value of 64, which indicates that the pixel signal S1 input at this time is the pixel signal with the low gray level. Therefore, the filter 110 selects the first filter parameter FT1 as the filter parameter, and performs the filter operation on the pixel signal S1 accordingly, so as to output the driving signal S2 to drive the light source module 200 to emit the light. The gray level value displayed by a local area 420A of the light source module 200 driving the display panel is as shown in FIG. 4A. According to FIG. 4A, when the pixel signal S1 with the low gray level is input, the light source driving circuit 100 drives the light source module 200 to reduce the probability of the halo phenomenon occurring in the local area 420A.

FIG. 4B is a schematic diagram of an image frame, a filter parameter, and an output of a light source module according to another embodiment of the disclosure. Referring to FIG. 1A and FIG. 4B, the pixel signal S1 input to the light source driving circuit 100 includes an image frame 410B. A pixel 456B therein is, for example, set as a pixel with a gray level value of 255, which indicates that the pixel signal S1 input at this time is the pixel signal with the high gray level. Therefore, the filter 110 selects the third filter parameter FT3 as the filter parameter, and performs the filter operation on the pixel signal S1 accordingly, so as to output the driving signal S2 to drive the light source module 200 to emit the light. The gray level value displayed by a local area 420B of the light source module 200 driving the display panel is as shown in FIG. 4B. According to FIG. 4B, when the pixel signal S1 with the high gray level is input, the light source driving circuit 100 drives the light source module 200, and the local area 420B thereof has the sufficient brightness to be output to the display panel.

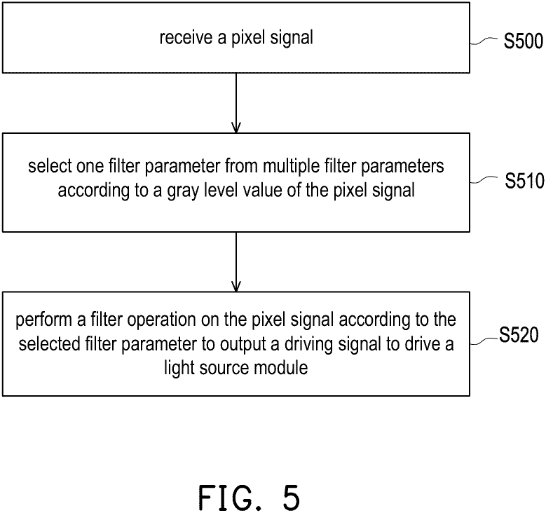

FIG. 5 is a flow chart of steps of a method for driving a light source according to another embodiment of the disclosure. Referring to FIG. 1A and FIG. 5, in step S500, the filter 110 in the light source driving circuit 100 receives the pixel signal S1. In step S510, the filter 110 selects the one filter parameter from the filter parameters FT1, FT2, and FT3 according to the gray level value of the pixel signal S1. In step S520, the filter 110 performs the filter operation on the pixel signal S1 according to the selected filter parameter, so that the light source driving circuit 100 outputs the driving signal S2 to drive the light source module 200.

Based on the above, in the embodiments of the disclosure, the filter of the light source driving circuit selects the centralized parameter array for the pixel signal at the low gray level, selects the distributed parameter array for the pixel signal at the high gray level, and selects the parameter array obtained by performing the interpolation operation on the pixel signal between the low gray level and the high gray level. That is, different filter parameters are adopted at each of the gray levels, which may optimize the local dimming function of the light source driving circuit and/or improve display quality of the display panel.

Finally, it should be noted that the above embodiments are only used to illustrate but not to limit the technical solutions of the disclosure. Although the disclosure has been described in detail with reference to the foregoing embodiments, persons skilled in the art should understand that they may still modify the technical solutions described in the foregoing embodiments or equivalently replace some or all of the technical features. However, the modifications or replacements do not cause the spirit of the corresponding technical solution to deviate from the scope of the technical solution according to each embodiment of the disclosure.

What is claimed is:

1. A light source driving circuit, comprising:
a filter configured to receive a pixel signal, select one filter parameter from a plurality of filter parameters according to a gray level value of the pixel signal, and perform a filter operation on the pixel signal according to the selected filter parameter to output a driving signal to drive a light source module,
wherein the filter parameters comprise a first filter parameter, a second filter parameter, and a third filter parameter, and the second filter parameter is obtained by performing an interpolation operation on the first filter parameter and the third filter parameter via the filter.

2. The light source driving circuit according to claim 1, wherein when the gray level value of the pixel signal is less than or equal to a first threshold value, the filter selects the first filter parameter.

3. The light source driving circuit according to claim 2, wherein when the gray level value of the pixel signal is greater than the first threshold value and less than a second threshold value, the filter selects the second filter parameter.

4. The light source driving circuit according to claim 3, wherein when the gray level value of the pixel signal is greater than or equal to the second threshold value, the filter selects the third filter parameter.

5. The light source driving circuit according to claim 1, wherein the pixel signal comprises pixel data of a plurality of pixels, and the filter calculates the gray level value of the pixel signal according to a maximum value of the pixel data and an average value of the pixel data.

6. The light source driving circuit according to claim 1, wherein the first filter parameter is a centralized parameter array.

7. The light source driving circuit according to claim 6, wherein the parameter array of the first filter parameter has a plurality of elements, a central element has a largest parameter value, and the parameter values of the rest of elements are zero.

8. The light source driving circuit according to claim 1, wherein the third filter parameter is a distributed parameter array.

9. The light source driving circuit according to claim 8, wherein the parameter array of the third filter parameter has a plurality of elements, and a central element has a largest parameter value, and the rest of elements are centered on the central element and decrease in order to a periphery.

10. The light source driving circuit according to claim 1, wherein the filter operation performed on the pixel signal via the filter comprises performing a convolution operation on the selected filter parameter and a weight value to obtain the driving signal, wherein the weight value is a weight value of each of light emitting units in a local area to be driven in the light source module.

11. A method for driving a light source configured to drive a light source module, comprising:
receiving a pixel signal;
selecting one filter parameter from a plurality of filter parameters according to a gray level value of the pixel signal; and
performing a filter operation on the pixel signal according to the selected filter parameter to output a driving signal to drive the light source module,
wherein the filter parameters comprise a first filter parameter, a second filter parameter, and a third filter parameter, and the second filter parameter is obtained by performing an interpolation operation on the first filter parameter and the third filter parameter.

12. The method for driving the light source according to claim 11, wherein selecting the one filter parameter from the filter parameters according to the gray level value of the pixel signal comprises:
selecting the first filter parameter when the gray level value of the pixel signal is less than or equal to a first threshold value.

13. The method for driving the light source according to claim 12, wherein selecting the one filter parameter from the filter parameters according to the gray level value of the pixel signal comprises:
selecting the second filter parameter when the gray level value of the pixel signal is greater than the first threshold value and less than a second threshold value, wherein the first threshold value is less than the second threshold value.

14. The method for driving the light source according to claim 13, wherein selecting the one filter parameter from the filter parameters according to the gray level value of the pixel signal comprises:
selecting the third filter parameter when the gray level value of the pixel signal is greater than or equal to the second threshold value.

15. The method for driving the light source according to claim 11, wherein the pixel signal comprises pixel data of a plurality of pixels, and the method for driving the light source further comprises:
calculating the gray level value of the pixel signal according to a maximum value of the pixel data and an average value of the pixel data.

16. The method for driving the light source according to claim 11, wherein the first filter parameter is a centralized parameter array.

17. The method for driving the light source according to claim 16, wherein the parameter array of the first filter parameter has a plurality of elements, a central element has a largest parameter value, and the parameter values of the rest of elements are zero.

18. The method for driving the light source according to claim 11, wherein the third filter parameter is a distributed parameter array.

19. The method for driving the light source according to claim 18, wherein the parameter array of the third filter parameter has a plurality of elements, and a central element has a largest parameter value, and the rest of elements are centered on the central element and decrease in order to a periphery.

20. The method for driving the light source according to claim 11, wherein the filter operation comprises performing a convolution operation on the selected filter parameter and a weight value to obtain the driving signal, wherein the weight value is a weight value of each of light emitting units in a local area to be driven in the light source module.
